(19) United States
(12) Patent Application Publication
(10) Pub. No.: US 2011/0306015 A1
(43) Pub. Date: Dec. 15, 2011

(54) ABUTMENT EXTENDER FOR ONE PIECE IMPLANT

(76) Inventor: Chun-Leon CHEN, Chang-Hua City (TW)

(21) Appl. No.: 12/815,912

(22) Filed: Jun. 15, 2010

(51) Int. Cl. A61C 8/00

(52) U.S. Cl. 433/173

(57) ABSTRACT

An abutment extender for use with a one piece implant in a dental implant surgery is disclosed to have a plug member insertable into the top hole of the one piece implant, an extension member located on the top side of the plug member and having a diameter equal to the diameter of the abutment of the one piece implant, a recessed hole located on the top side of the extension member, and a screw inserted into the recessed hole and for threading through the plug member into the abutment of the one piece implant to affix the extension member and the plug member to the one piece implant.

### BACKGROUND OF THE INVENTION

1. Field of the Invention

The present invention relates to dental implant technology and more particularly, to an abutment extender for one piece implant that is connectable to a one piece implant to extend the abutment for application to a patient having a high gum.

2. Description of the Related Art

For the sack of dental health and beauty, dental implant has become a common surgery. Conventionally, a dental implant surgery is to embed an implant in the patient's gum, and then to thread an abutment into the implant, and then to install a crown in the abutment after wound healed, and thus the dental implant surgery is done.

There is known a one piece implant design, which has the abutment and the implant made in integrity to facilitate installation of the abutment and the implant at one time. As shown in FIGS. 1 and 4, a one piece implant 2 comprises a shank 23 having an integrated abutment 22 at the top side thereof. After installation of the one piece implant 2 in the gum 4, the abutment 22 protrudes over the top side of the gum 4 to facilitate installation of a crown 3.

However, due to that every patient has a different height of gum 4, installing a one piece abutment in a relatively higher gum 4, the abutment 22 of the one piece implant 2 may go down in the gum 4. When this problem occurs, the dentist may be unable to install a crown 3 to the abutment 22.

### SUMMARY OF THE INVENTION

The present invention has been accomplished under the circumstances in view. It is the main object of the present invention to provide an abutment extender for one piece implant that is connectable to a one piece implant to extend the abutment for application to a patient having a high gum.

To achieve this and other objects of the present invention, an abutment extender for use with a one piece implant in a dental implant surgery comprises a plug member insertable into the top hole of the one piece implant, an extension member located on the top side of the plug member and having a diameter equal to the diameter of the abutment of the one piece implant, a recessed hole located on the top side of the extension member, and a screw inserted into the recessed hole and for threading through the plug member into the abutment of the one piece implant to affix the extension member and the plug member to the one piece implant.

Thus, the use of the abutment extender widens the application range of a one piece implant, facilitating application of a dental implant surgery to a patient having a high gum.

### BRIEF DESCRIPTION OF THE DRAWINGS

FIG. 1 is an exploded view a conventional one piece implant and an abutment extender made in accordance with a first embodiment of the present invention.

FIG. 2 is an elevational assembly view of FIG. 1.

FIG. 3 is a schematic sectional view, showing the assembly of the one piece implant and the abutment extender of FIG. 2 installed in a patient's gum.

FIG. 4 is a schematic sectional view, showing a conventional one piece abutment installed in a patient's gum.

FIG. 5 is an exploded view of a second embodiment of the present invention.

FIG. 6 is a sectional exploded view of the second embodiment of the present invention.

FIG. 7 corresponds to FIG. 6, showing the abutment extender affixed to the one piece implant.

FIG. 8 is a cross sectional view taken along line A-A of FIG. 7.

FIG. 9 is a sectional exploded view of a third embodiment of the present invention.

FIG. 10 is a sectional exploded view of a fourth embodiment of the present invention.

FIG. 11 is a sectional exploded view of a fifth embodiment of the present invention.

FIG. 12 is a sectional exploded view of a sixth embodiment of the present invention.

### DETAILED DESCRIPTION OF THE PREFERRED EMBODIMENT

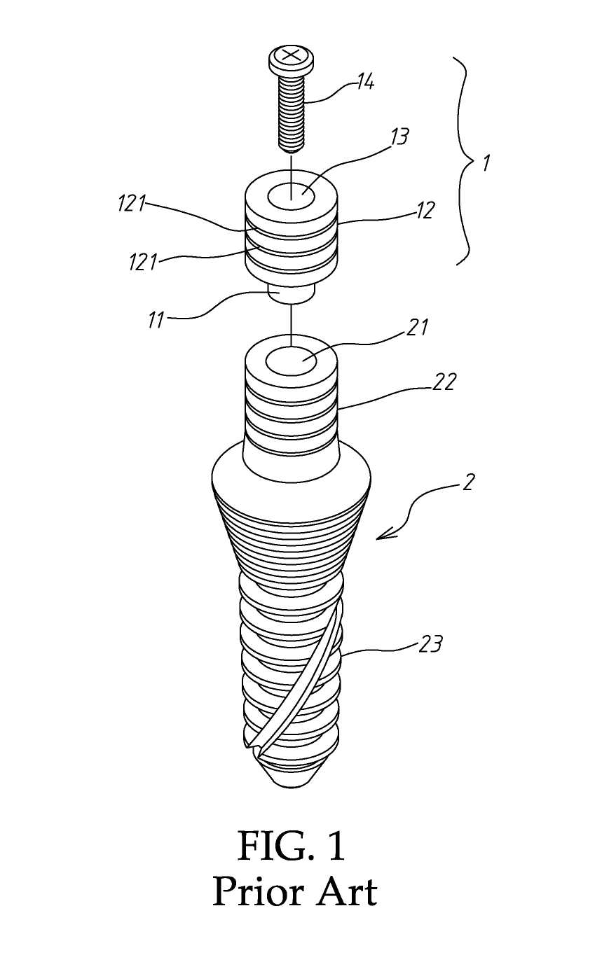

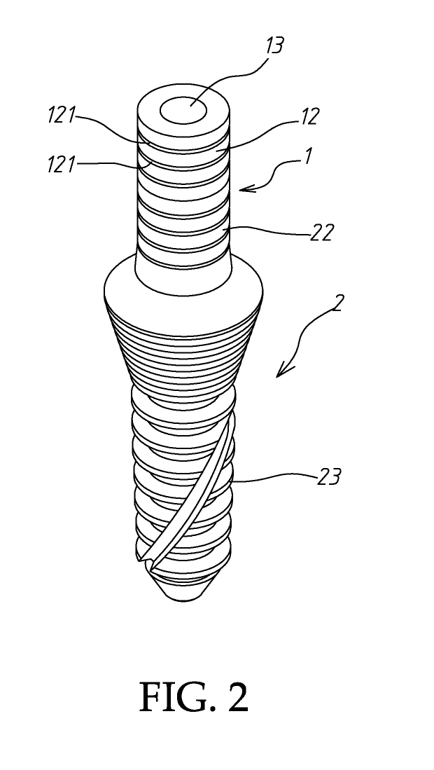

Referring to FIGS. 1˜3, an abutment extender 1 is shown for use with a one piece implant 2. The abutment extender 1 comprises a plug member 11, an extension member 12, a recessed hole 13 and a screw 14.

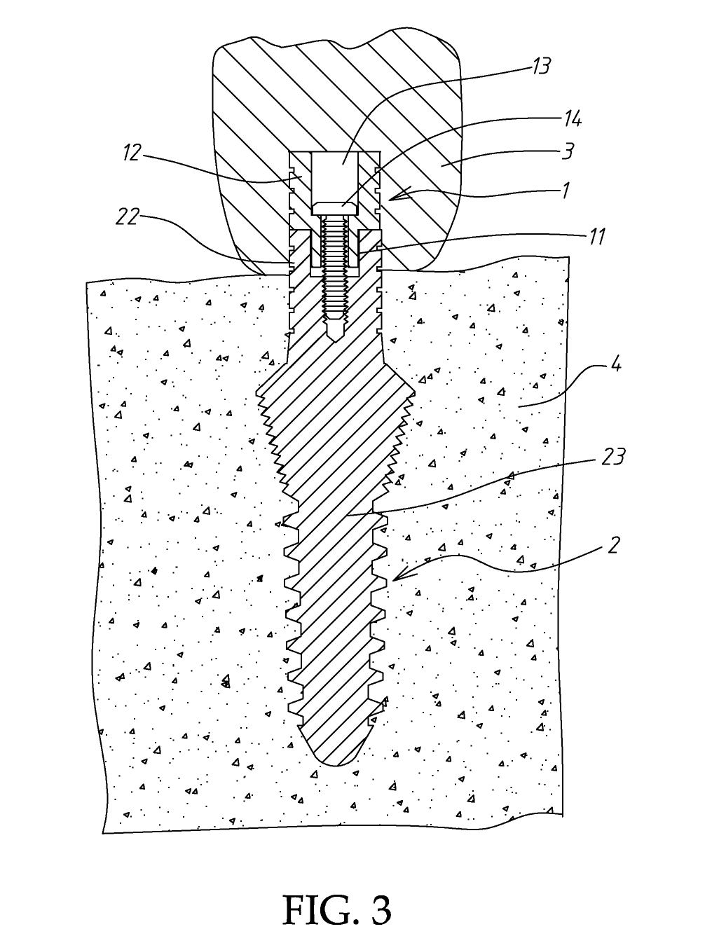

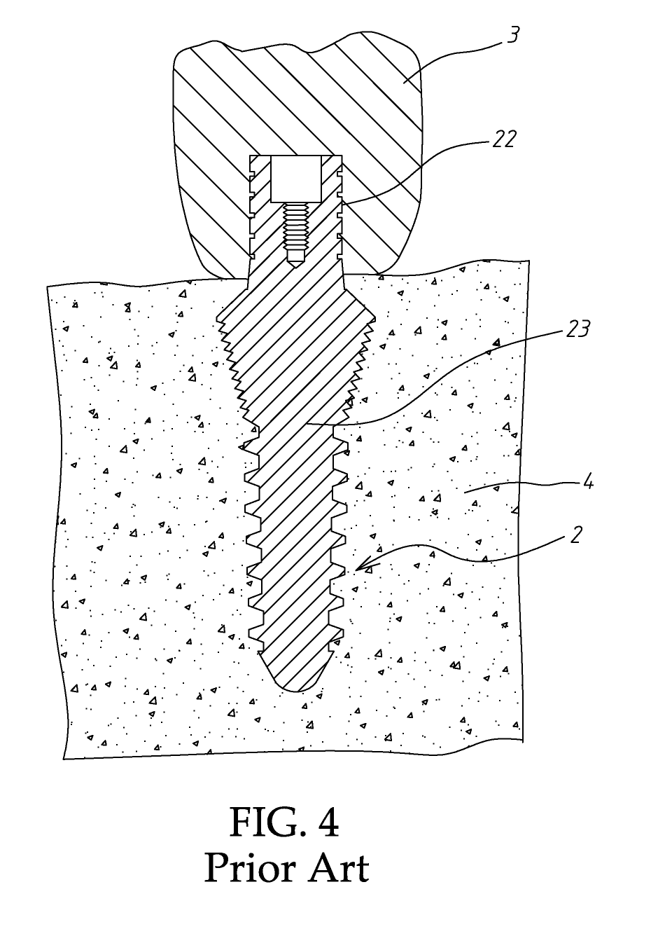

The plug member 11 is press-fitted into a top hole 21 on the one piece implant 2. The extension member 12 is formed integral with the top side of the plug member 11, having a diameter equal to the diameter of the abutment 22 of the one piece implant 2. After installation of the plug member 11 in the top hole 21 of the one piece implant 2, the extension member 12 is abutted against the topmost edge of the abutment 22 of the one piece implant 2 in a flush manner. The recessed hole 13 is located on the top side of the extension member 12 and extends axially downwardly toward the plug member 11. The screw 14 is to be inserted into the recessed hole 13 and axially threaded through the plug member 11 into the abutment 22 to affix the extension member 12 and the plug member 11 to the one piece implant 2 (see FIG. 3).

Further, the extension member 12 has at least one groove 121 extending around the periphery to facilitate engagement of a crown 13 (see FIG. 3).

Normally, the shank 23 of the one piece implant 2 is implanted into the gum 4, and the abutment 22 is kept above the top edge of the gum 4 for the installation of the crown 3. However, if a patient has a relatively higher gum 4, the one piece implant 2 will be completely embedded into the gum 4, as shown in FIG. 3, and the abutment 22 will partially sink in the gum 4. At this time, the abutment extender 1 must be used. By means of inserting the screw 14 into the recessed hole 13 and axially threading the screw 14 through the plug member 11 into the abutment 22, the abutment extender 1 is affixed to the one piece implant 2 to hold the extension member 12 above the gum 4 for the installation of the crown 3.

Obviously, the use of the abutment extender 1 widens the application range of the one piece implant 2, facilitating application of a dental implant surgery to a patient having a high gum.

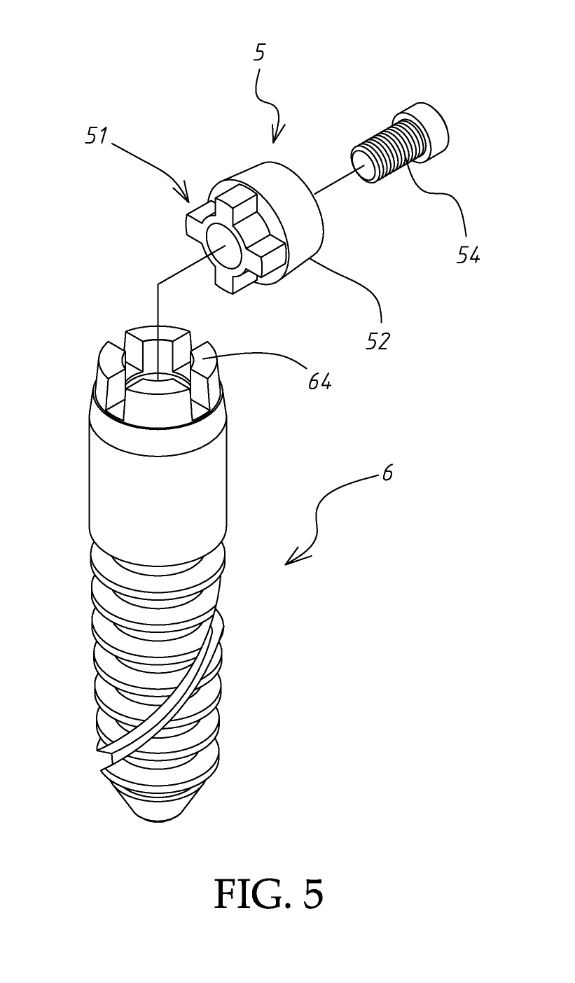

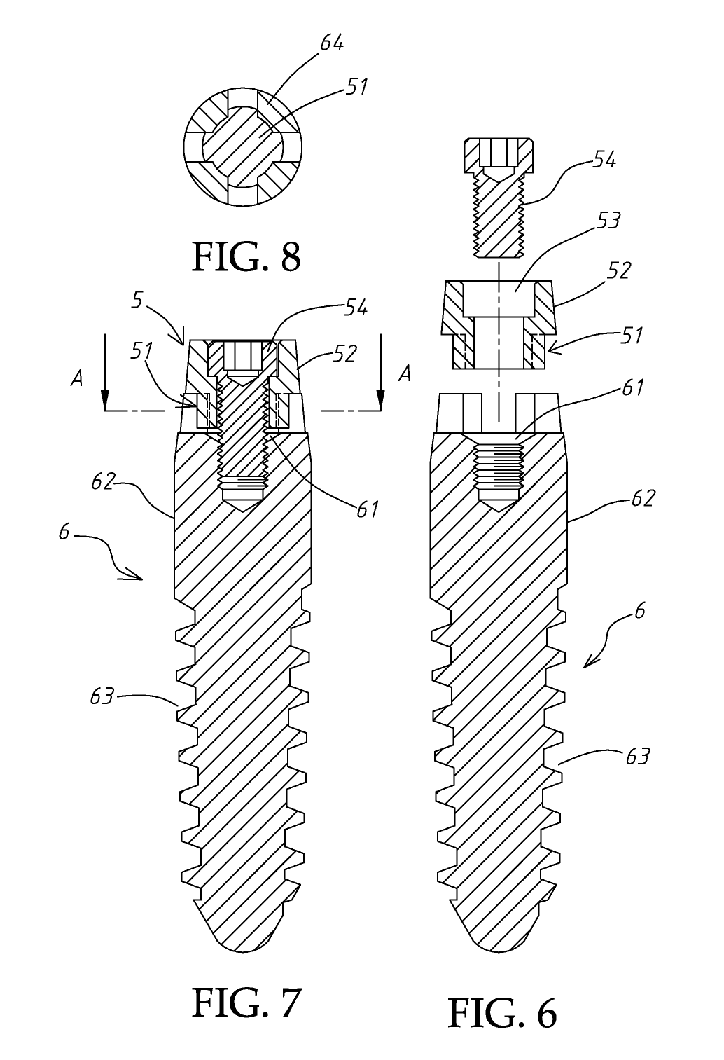

Referring to FIGS. 5˜8, an abutment extender 5 in accordance with a second embodiment of the present invention is shown for use with a one piece implant 6. The abutment extender 5 comprises a plug member 51, an extension member 52, a recessed hole 53 and a screw 54. The one piece implant 6 comprises a shank 63, an abutment 62 formed integral with the top side of the shank 63, a top hole 61 located on and axially downwardly extended from the top side of the abutment 62 and a mounting groove 64 located on the top side of the abutment 62 around the top hole 61.

The abutment extender 5 of this second embodiment is substantially similar to the aforesaid first embodiment with the exception that the plug member 51 of the abutment extender 5 of this second embodiment has a star-shaped profile fitting the star-shaped configuration of the mounting groove 64. Thus, when the plug member 51 of the abutment extender 5 is press-fitted into the mounting groove 64 of the one piece implant 6, the abutment extender 5 is prohibited from rotation relative to the one piece implant 6. Thus, the use of the abutment extender 5 greatly extends the height of the abutment 62 of the one piece implant 6.

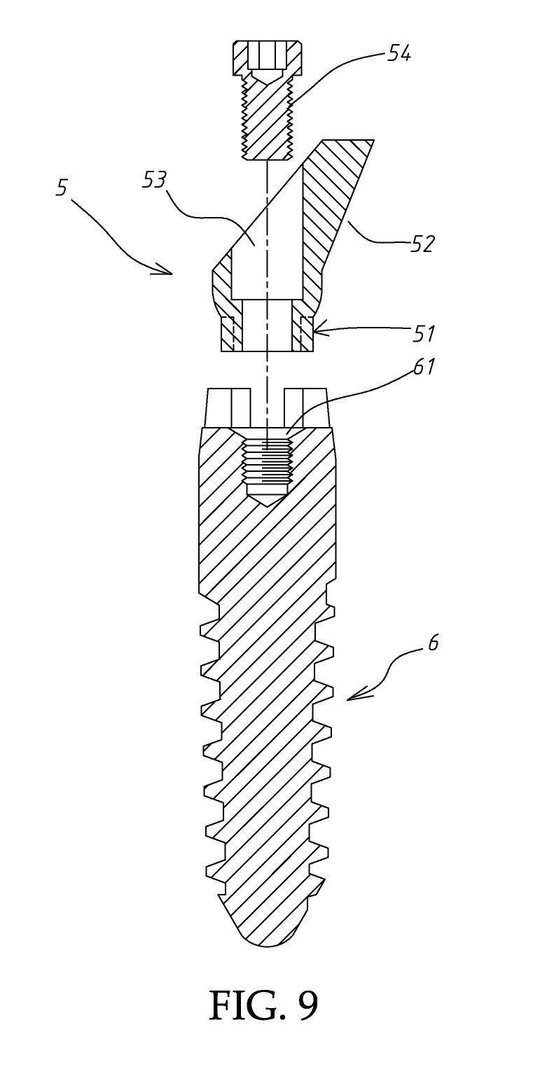

Referring to FIG. 9, an abutment extender 5 in accordance with a third embodiment of the present invention is shown for use with a one piece implant 6. This abutment extender 5 of this third embodiment is substantially similar to the aforesaid second embodiment with the exception that the extension member 52 extends obliquely in one direction to fit a patient having an inclined gum. However, the recessed hole 53 is kept in axial alignment with the top hole 61 of the one piece implant 6, facilitating installation of the screw 54.

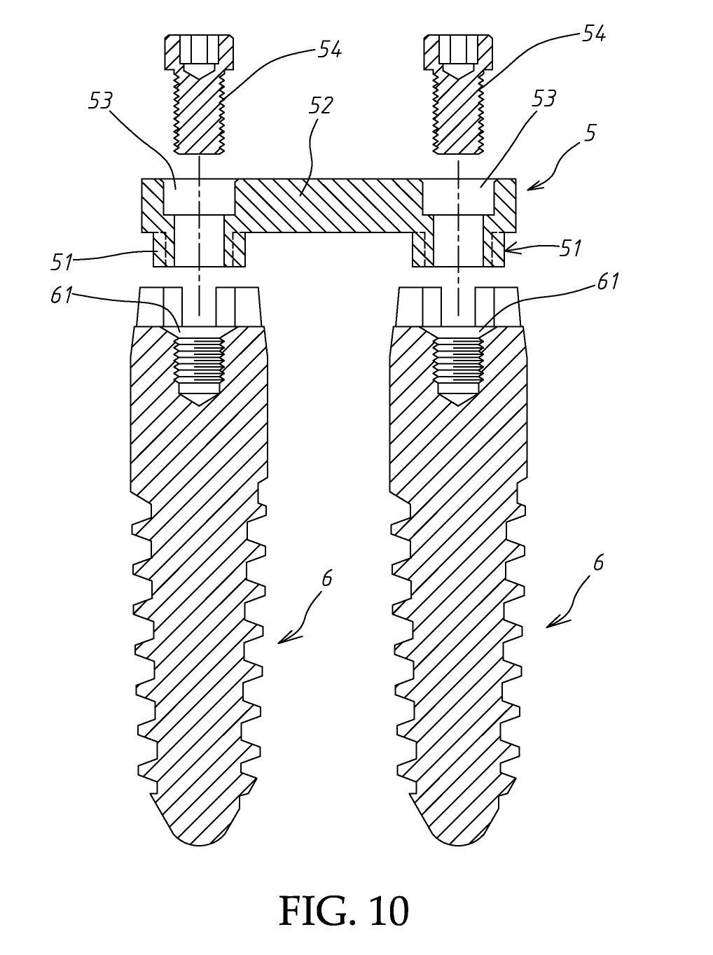

Referring to FIG. 10, an abutment extender 5 in accordance with a fourth embodiment of the present invention is shown for use with two pieces of one piece implants 6. The abutment extender 5 comprises two plug members 51, an extension member 52, two recessed holes 53 and two screws 54. The two plug members 51 are respectively the top hole 61 of each of the two pieces of one piece implants 6. The two screws 54 are respectively inserted into the recessed holes 53 to affix the abutment extender 5 to the two pieces of one piece implants 6. Thus, a dentist can implant two pieces of one piece implants 6 at one time.

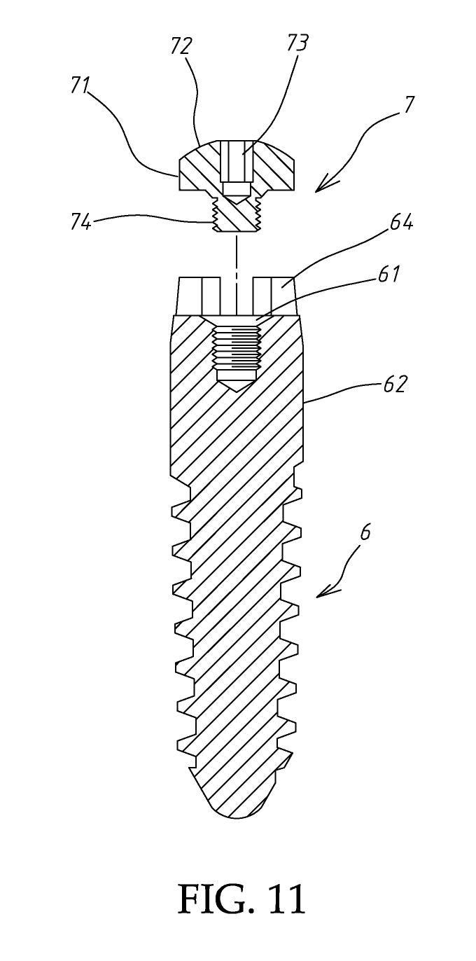

Referring to FIG. 11, an abutment extender 7 in accordance with a fifth embodiment of the present invention is shown for use with a one piece implant 6. The abutment extender 7 comprises a plug member 71, an extension member 72, a recessed hole 73 and a screw 74. The plug member 71 has a star-shaped profile fitting the mounting groove 64 of the one piece implant 6. The screw 74 is located on the bottom side of the plug member 71 for threading into the top hole 61 of the one piece implants 6 directly. The extension member 72 is adapted to increase the height of the abutment 62 of the one piece implant 6. The recessed hole 73 extends axially downwardly from the topmost edge of the extension member 72 for the mounting of a crown or any other object.

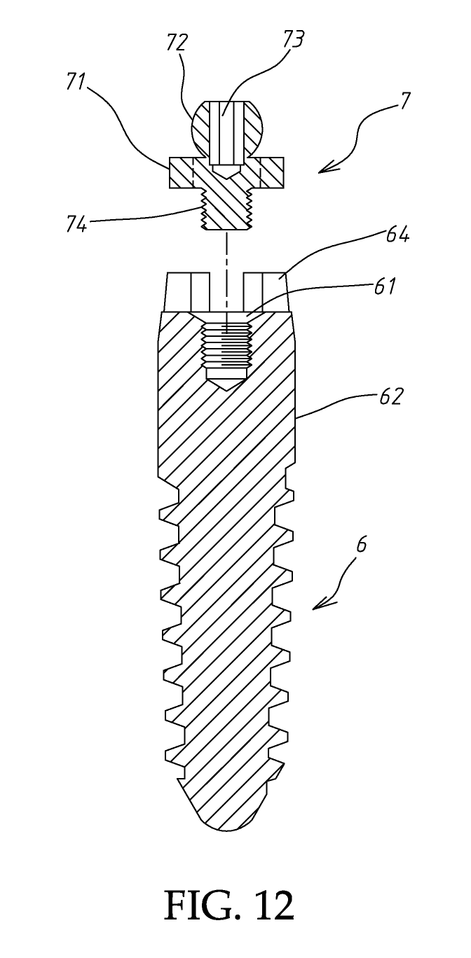

FIG. 12 illustrates an abutment extender 7 in accordance with a sixth embodiment of the present invention. This sixth embodiment is substantially similar to the aforesaid fifth embodiment with the exception of the ball-like shape of the extension member 72.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An abutment extender used with a one piece implant having a shank, an abutment located on a top side of said shank and a top hole located on a top side of said abutment, comprising:
a plug member insertable into the top hole of said one piece implant;
an extension member located on a top side of said plug member;
a recessed hole located on a top side of said extension member and extending axially downwardly toward said plug member; and
a screw inserted into said recessed hole and for threading through said plug member into the abutment of said one piece implant to affix said extension member and said plug member to said one piece implant.

2. The abutment extender as claimed in claim 1, wherein said extension member comprises at least one groove extending around the periphery thereof.

3. The abutment extender as claimed in claim 1, wherein said extension member has a diameter equal to the diameter of the abutment of said one piece implant

4. The abutment extender as claimed in claim 1, wherein said plug member has a star-shaped profile fitting a star-shaped mounting groove on said one piece implant.

5. The abutment extender as claimed in claim 3, wherein said extension member is shaped like a ball.

6. The abutment extender as claimed in claim 3, wherein said extension member extends obliquely in one direction relative to said plug member; said recessed hole is kept in axial alignment with the top hole of said one piece implant.

7. An abutment extender used with two pieces of one piece implants in a dental implant surgery, each said one piece implant having a shank, an abutment located on a top side of said shank and a top hole located on a top side of said abutment, comprising:
two plug members insertable into the top holes of said two pieces of one piece implants;
an extension member located on a top side of each said plug member, said extension member;
two recessed holes located on a top side of said extension member corresponding to said plug members; and
two screws respectively inserted into said recessed holes and for threading through said plug members into the abutments of said two pieces of one piece implants to affix said extension member and said plug members to said two pieces of one piece implants.
